(19) United States
(12) Patent Application Publication
(10) Pub. No.: US 2013/0218610 A1
(43) Pub. Date: Aug. 22, 2013

(54) Method and System for Aggregating Travelers to Transact Air Travel Reservations

(71) Applicants: Sascha Mornell, San Francisco, CA (US); Rafael Collado, Chesapeake, VA (US)

(72) Inventors: Sascha Mornell, San Francisco, CA (US); Rafael Collado, Chesapeake, VA (US)

(73) Assignee: ZigAir LLC, Chesapeake, VA (US)

(21) Appl. No.: 13/402,059

(22) Filed: Feb. 22, 2012

(51) Int. Cl. G06Q 10/02

(52) U.S. Cl. 705/5

(57) ABSTRACT

A method and system for aggregating travelers to transact air travel reservations with air travel suppliers, whereby travelers can purchase seats for private air travel on a per-seat basis and suppliers can solicit travelers on a central forum on a per-plane, per-flight basis. The method and system incorporates at least one database and a reservation engine in the form of one or more computers. The method and system is operable to receive flight information from air travel suppliers and display the information over the internet in the form of one or more Web pages. The method and system is further operable to receive reservation requests from travelers viewing the Web pages, and aggregate the requests to enable travelers to collectively purchase private air travel.

### FIELD

The present invention relates to air travel reservations, in particular, a method and system to enable owners and operators of private aircraft to solicit travelers for flights, and a method and system to aggregate travelers to share the costs of private air travel.

### BACKGROUND

Air travel is becoming an ever increasingly predominant method of travel. Travelers, however, possess limited options for air travel reservations. There are two broad options for air travel—commercial air travel and private air travel. Customer satisfaction in the commercial air travel industry is at an all-time low. Increasing crowds, enhanced security, and increasingly prevalent delays all contribute to an unpleasant travel experience. While private air travel remedies many of the disagreeable aspects of commercial air travel, it is cost prohibitive to the average traveler. Currently the exclusive method for suppliers of private air travel to market and sell private air travel services is through chartering flights by the plane, by the hour. This model requires that a traveler, or group of travelers, coordinate payment for the entire plane reservation. Not surprisingly, private air travel is essentially limited to institutional clients and individuals with substantial financial means. Furthermore, this method is inefficient and requires substantial coordination between travels and flight operators.

Private air travel suppliers have attempted to bring the costs of private air travel down by employing methods such as “fractional ownership” or private air travel “clubs.” Through these methods, travelers can buy a membership into a private air travel operation, thus receiving discounts and benefits of membership. Nevertheless, costs under these methods still remain unreasonably high for the average traveler, and planes must still be reserved by the hour.

What is needed, therefore, is a system that enables plane owners to advertise and transact air travel reservations on per flight, per plane basis, while enabling travelers to collectively purchase available seats on private air planes such that travelers can purchase private air travel on a per seat basis, thereby drastically reducing costs and time. An effective method of making private air travel broadly affordable, while simultaneously providing an outlet for private plane owners to market air travel reservations, has eluded those skilled in the art.

### SUMMARY

While many private air travel companies, such as those described above, currently provide air travel services, the vast majority of private planes in the United States go unused every day. This represents a significant impediment of overall national economic productivity. The reason for this is there is a lack of an efficient and cost effective method of marketing and transacting reservations with large groups of travelers. For a private plane owner to solicit travelers in the current market, the plane owner would have to establish its own channels of marketing and sales to secure air travel reservations. This is simply not cost effective for plane owners who only make occasional flights, or who do not wish to manage a commercial air travel operation.

An embodiment of the present invention is an air travel reservation transaction system comprising at least one database receiving input from a user operable to store supplier-generated information and traveler-generated information; and a transaction engine operable to receive a reservation request; access a database to obtain supplier-generated information and traveler-generated information associated with the reservation request; aggregate the reservation request with other reservation requests stored in a database; and complete a transaction associated with the reservation request.

Another embodiment is an air travel reservation system comprising at least one database, receiving input from a user, operable to store supplier-generated information and traveler-generated information; and a reservation engine operable to receive a reservation request, the reservation request including one or more parameters; access a database to obtain information associated with the request; aggregate the reservation request with other reservation requests stored in the database; determine whether the reservation request satisfies the air travel reservation parameters in the database; and create a reservation according to the reservation request.

Another embodiment is a computer implemented method for making air travel reservations, comprising receiving air travel options and parameters from an air travel supplier; storing the air travel options and parameters into one or more databases; displaying the air travel options and parameters over the Internet through the use of one or more Web pages, the one or more Web pages accessible to Internet users; receiving an air travel reservation request from an Internet user; aggregating the air travel reservation request with similar air travel reservation requests; determining whether the air travel reservation request satisfies the air travel options and parameters received by the air travel supplier; and creating an air travel reservation.

This and other advantages will become clearer in the following drawings, descriptions, and claims.

### BRIEF DESCRIPTION OF DRAWINGS

FIG. 1 is a logical flow diagram generally illustrating processes performed by one implementation of the present invention.

FIG. 2 is a logical flow diagram generally illustrating one method of implementation of the present invention.

FIG. 3 is an exemplary air travel reservation system incorporating the teachings of the present invention.

FIGS. 4-7 illustrate exemplary supplier information pages that may be communicated by the air travel reservation system.

FIG. 8 illustrates an exemplary supplier confirmation page that may be communicated by the air travel reservation system.

FIGS. 9-11 illustrate exemplary reservation request pages that may be communicated by the air travel reservation system.

FIG. 12 illustrates an exemplary reservation confirmation page that may be communicated by the air travel reservation system.

FIG. 13 illustrates an exemplary flight notification page that may be communicated by the air travel reservation system.

### DETAILED DESCRIPTION

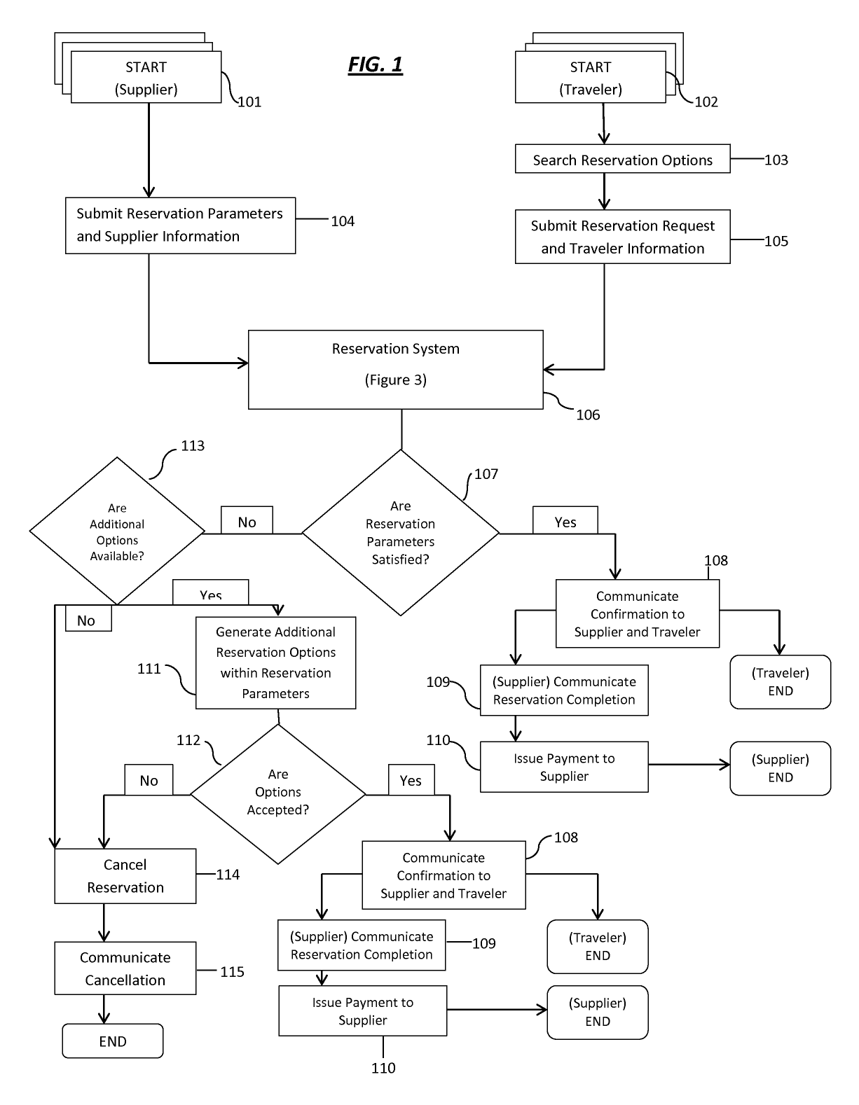

FIG. 1 is a logical flow diagram generally illustrating processes performed by one implementation of the present invention. In the current embodiment, a supplier computing device 101 and a traveler computing device 102 are used to submit supplier-generated and traveler-generated information, respectively. The term “supplier” is meant to refer to any individual, party, entity, or combination thereof that seeks to offer air travel reservations via the air travel reservation system 106; and may be used interchangeably with “provider,” or “user.” The term “traveler” is meant to refer to any individual or entity that seeks to obtain a reservation for air travel from a supplier through air travel reservation system 106, and may be used interchangeably with “passenger” or “user.” Supplier computing device 101 and traveler computing device 102 refer generally to electronic computing devices, and may be, for example, a personal computer, a handheld device such as a cell phone or a tablet computer, multi-processor systems, microprocessor-based or programmable consumer electronics, network PCs, minicomputers, mainframe computers, and the like. An embodiment may also be practiced in distributed computing environments where tasks are performed by remote processing devices that are linked through a communications network. In a distributed computing environment, program modules may be located in both local and remote memory storage devices. Computing devices 101 and 102 may also include one or more input devices such as a keyboard, mouse, pen, voice input device, touch input device, scanner, or the like. One or more output devices may also be included, such as a video display, audio speakers, a printer, or the like. Input and output devices are well known in the art and need not be discussed at length here.

In the embodiment, the supplier and the traveler use an above computing device to submit reservation parameters and supplier information 104, and to search reservation options 103 and submit reservation request and traveler information 105, respectively. Reservation parameters and supplier information 104 includes especially, but is not limited to, the supplier's Federal Aviation Association (FAA) 135 certification number; contact e-mail; contact phone; company name; address; an account password; plane tail number; base airport; aircraft type; aircraft manufacturer; aircraft model; blackout dates; passenger and cargo weight requirements; usable seats; aircraft description; images; reservation parameters, including aircraft availability, aircraft status, flight destination, total requested price for flight, flight schedule, and flight frequency.

In the embodiment, the traveler browses the supplier reservation parameters and supplier information 104 through the use of one or more World Wide Web (“Web”) pages displayed over traveler computing device 102, communicated by reservation system 106. Upon making a reservation decision, the traveler submits the reservation request and traveler information 105. Reservation request and traveler information 105 is meant to include especially, but is not limited to, the traveler's first and last name; contact e-mail; account password; passenger or passengers' names and dates of birth; and credit card information, including billing address, billing city, billing state, billing zip, name on card, card number, expiration month, expiration year, and security code. A “reservation” means a confirmed or contingent intent, communicated by a traveler to reservation system 106, to purchase a seat or seats on a supplier's aircraft, or a supplier's affiliate, agent, or assignee's aircraft, for an offered flight communicated by reservation system 106.

Reservation parameters and supplier information 104 and reservation request and traveler information 105 are submitted to reservation system 106. Reservation system 106 may be a computing device of the same nature and function as 101 or 102 described above, and may include at least one processing unit and system memory. Depending on the exact configuration and type of computing device, system memory may be volatile (such as RAM), non-volatile (such as ROM, flash memory, etc.) or some combination of the two. Reservation system 106 may also include additional storage (removable and non-removable) including, but not limited to, magnetic or optical discs or tapes. Computer storage media may include volatile and nonvolatile, removable and non-removable media implemented in any method or technology for storage of information such as computer-readable instructions, data structures, program modules, or other data.

In an embodiment, reservation system 106 includes a reservation engine 313 that may receive and process reservation parameters and supplier information 104 and reservation request and traveler information 105. Reservation engine 313 may communicate reservation confirmations and cancellations to suppliers, travelers, or requesters; store air travel options and parameters into one or more databases; aggregate reservation requests for solicited or advertised flights to satisfy reservation parameters; conduct financial transactions pertaining to reservations; and perform any other appropriate functions related to the booking of reservations. Reservation engine 313 may be a microprocessor or other comparably functional computer-implemented device within or without the hardware structure of reservation system 106. Reservation engine 313 is coupled to a reservation master database 314 that includes supplier and traveler information, including reservation parameters and supplier information 104 and reservation request and traveler information 105. Reservation engine 313 may be coupled to reservation master database 314 through wireless or wireline system networking, or may be hardwired as an integral part of the same computer system. Reservation engine 313 is also coupled to an inventory database 315, which may be integral to or separate from reservation master database 314. Inventory database 315 may include data indicating the number of available flights, pricing, flight destinations, and flight dates and times.

In an embodiment, reservation system 106 performs a series of functions to confirm an air travel reservation and conduct a transaction. Upon receiving reservation request and traveler information 105, reservation system 106 determines whether reservation parameters are satisfied 107. Reservation parameters include specifically, but are not limited to, satisfying the total flight price or seats requested by the supplier using an algorithm that matches continuously updated statistical information about flight availability (between pre-determined locations, transportation system capacity and statutory mandates and optimizes them in a manner that yields an acceptable probability of the travel user being able to fly at (or near) the time they've requested and guarantees the provider an acceptable economic return. A simplified example of this algorithm is illustrated below. If the reservation request, either alone or aggregated with other reservation requests for the same flight, satisfies the price requested by the supplier then a transaction associated with the reservation is completed. For example, an air travel supplier communicates to the reservation system that a flight is available for a given date; the air travel supplier has four seats on its plane and needs $2,000 to execute the flight. The reservation engine will perform a basic algorithm to create a per seat price, e.g. (Price of Flight)/(Number of Seats)=(Price per seat). In the example, the price per seat would be $500; e.g. ($2000)/(4 seats)=$500 per seat. The reservation system will then display the price per seat over one or more Web pages in an attempt to obtain reservation requests for all seats. The reservation system will store and aggregate the reservation requests to collectively satisfy the required plane price. For example, if there are three travelers requesting each requesting one seat for the flight in the above example, the reservation system would aggregate the three reservation requests to determine that one more request is needed to execute the flight. If the reservation engine receives enough reservation requests to satisfy the price of the flight then reservations would be confirmed and transacted. If the reservation system does not receive enough reservation requests, the reservation system would communicate to the travelers requesting reservations that the flight has not been filled and give the travelers the option of purchasing an additional seat or seats to satisfy the flight cost. Using the above illustration as an example, if four seats are available at a cost of $500 per seat and only one traveler requests a reservation, at some point prior to the execution of the flight, for example 48 hours, the reservation system would communicate to the traveler that in order for the flight to proceed, the additional three seats will need to be purchased. If the traveler wishes to proceed with the flight, the traveler will purchase the other three seats for a total flight cost of $2,000. If the traveler does not wish to purchase the seats, the flight will not be completed and the reservation will be cancelled.

The reservation system is capable of receiving funds from a traveler and routing the funds to one or more accounts associated with the transaction. A reservation confirmation 108 is communicated to the traveler and supplier. Upon completion of the flight, the supplier communicates the reservation completion 109 to the reservation system 106. A “reservation completion” means completion of the flight associated with the traveler, or travelers, reservation. Upon receiving the reservation completion communication 109, the reservation system issues a payment to the supplier in the amount requested by the supplier in reservation parameters and supplier information 104, less any potential fees or charges that may be associated with the transaction.

In an embodiment, if reservation parameters 107 are not satisfied, reservation system 106 determines if additional options are available 113 that may be similar to the traveler's reservation request. In an exemplary embodiment, reservation system 106 waits until 48 hours before the requested flight's departure to determine if reservation parameters 107 are satisfied. “Additional options” includes especially, but are not limited to, purchasing more seats on the offered flight, purchasing a seat on a different flight leaving from a similar location at a similar time, or a combination thereof. If no additional options are available, a reservation cancellation 114 is conducted by reservation system 106 and a cancellation communication 115 is communicated to the supplier and traveler.

In an embodiment, if additional options are available, reservation system 106 generates additional reservation options 111 meeting reservation parameters. The additional options are communicated to the traveler. For example, if there are insufficient reservation requests to execute a flight, as illustrated in the above example, the reservation system may generate additional reservation options. Additional reservation options can include buying more seats on the flight to satisfy the cost parameters supplied by the air travel provider, or buying a seat on a different plane leaving from a comparable location at a comparable time. If the traveler accepts the additional options 112, then a reservation confirmation 108 is communicated to the traveler and supplier, and a transaction is conducted according to steps 109 and 110, as more fully illustrated above. If the additional options are not accepted by the traveler, then the reservation is cancelled in accordance with steps 114 and 115, as more fully illustrated above.

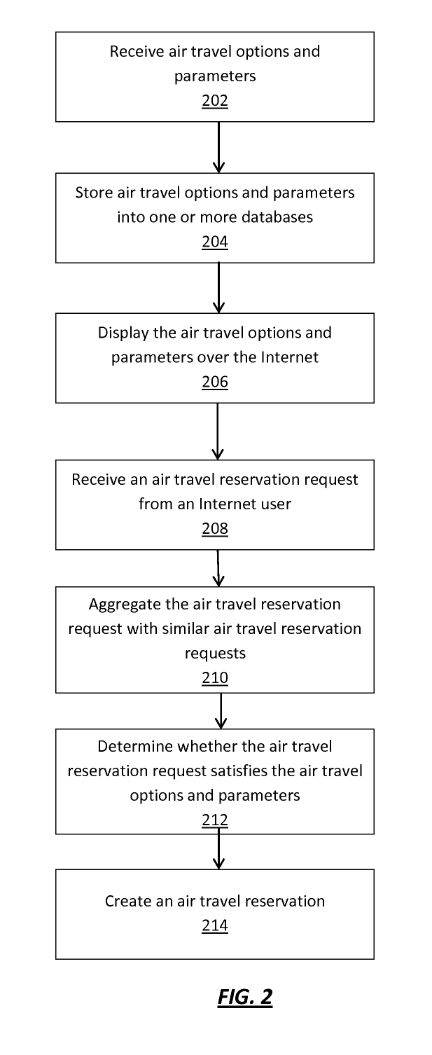

FIG. 2 is a logical flow diagram generally illustrating one method of implementation of the present invention. In an embodiment, air travel reservations are completed through a computer-implemented method comprising receiving air travel options and parameters 202 from an air travel supplier; storing the air travel options and parameters into at least one database 204; displaying the air travel options and parameters over the Internet 206 through the use of at least on Web page, the Web page accessible to Internet users; receiving an air travel reservation request from an Internet user 208; aggregating the air travel reservation request with similar air travel reservation requests 210; determining whether the air travel reservation request satisfies the air travel options and parameters 212 received by the air travel supplier; and creating an air travel reservation 212. The “computer” used to implement the method can be of the same form and function as that of 101 and 102 above.

In the above embodiment, the computer implemented method for making air travel reservations may further function to combine the aggregated air travel reservation requests to collectively satisfy the air travel parameters communicated by the air travel supplier and generate reservations for the aggregated air travel reservation requests.

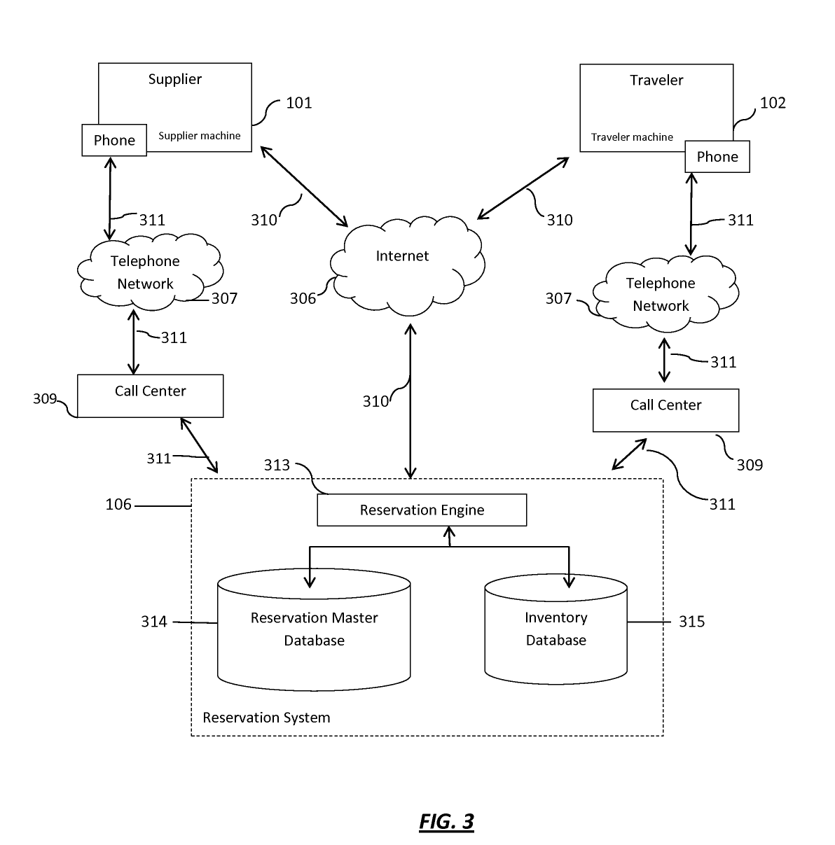

FIG. 3 is an exemplary air travel reservation system incorporating the teachings of the present invention. In an embodiment, reservation system 106 may be coupled to the Internet or other suitable wireline or wireless network 310 that supports communications between one or more computers. In a particular embodiment, reservation system 106 includes Hypertext Markup Language (HTML) documents or other suitable documents that may be communicated over Internet 306 for display to computers 101 and 102. The term “Web pages” encompasses HTML documents and any other appropriate techniques of displaying content using Internet 306, such as Extensible Markup Language (XML) documents. Computers such as 101 and 102, and reservation system 106, may include interfaces, Web browsers, or any other hardware, software or other components to facilitate connection to Internet 306 and display of web pages. Web pages that are used in the operation of reservation system 106 may be stored in reservation master database 314 or any other appropriate storage medium associated with reservation system 106.

Reservation system 106 may also be coupled through a wireline or wireless connection 311 to a call center 309. Call center 309 may be coupled to any appropriate telephone network 307, such as voice over internet protocol (VoIP), and includes one or more operators that receive calls from telephone users coupled to the telephone network 307. Instead of or in addition to communicating Web pages to computers 101 and 102, reservation system 106 communicates to call center 309. These calls scripts may be displayed on a computer so that the operator can read the script to a user that has called a call center 309 using a telephone.

In an exemplary embodiment, reservation system 106 is maintained and run by a third party, for example a company registered as a seller of travel in applicable jurisdictions. The third party may generate content of Web pages displayed to Internet users; and may make decisions on how to price air travel by the seat based upon the supplier's price parameters, total available seats, and other applicable supplier parameters. The third party may designate a cost markup on top of the supplier's price parameters, and pass that markup on to travelers in the form of a higher price per seat or total flight price. The third party may also exercise control over funds associated with transactions. In an exemplary embodiment, the traveler will conduct a transaction associated with its reservation through reservation system 106. The third party will receive funds and from travelers and issue a payment in accordance with steps 109 and 110 above, and retain a price markup designated by the third party.

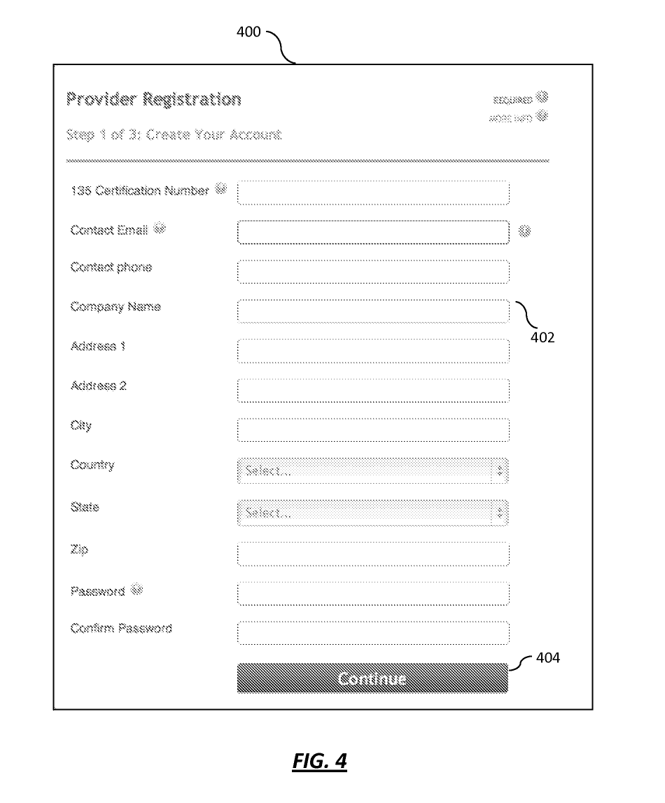

FIG. 4 illustrates an exemplary supplier information page that may be communicated by the air travel reservation system. In an embodiment, a provider registration page 400 is displayed to an Internet user through the use of a Web page to create an account for a supplier seeking to offer air travel services through reservation system 106. Provider registration page 400 is capable of receiving information in one or more fields 402 from the Web page user. Fields 402 are used to obtain information about the supplier, such as FAA 135 certification number and contact information. Included in provider registration page 400 is a “Continue” button 404. By engaging “Continue” button 404, the user submits the information contained in fields 402 to reservation engine 313, thereby being stored in one or more databases, for example reservation master database 314. Storage of user information creates a provider or supplier account, thereby enabling identification of the supplier or provider upon being prompted to submit a unique account password in a user interface. Upon creation of a provider or supplier account, the account holder is able to upload flight information data, as provided below. Storage media includes volatile and nonvolatile, removable and non-removable media implemented in any method or technology for storage of information such as computer readable instructions, data structures, program modules, or other data.

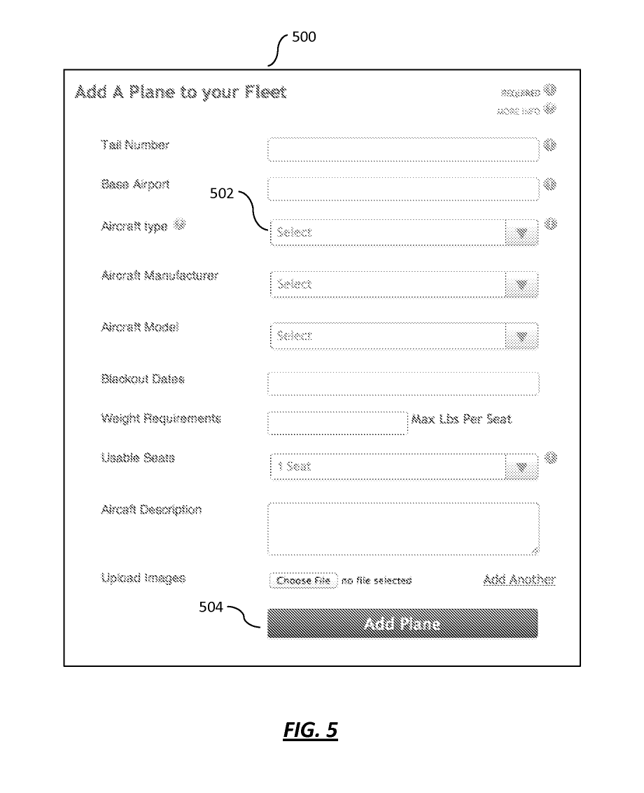

FIG. 5 illustrates an exemplary plane information page that may be communicated by the air travel reservation system. In an exemplary embodiment, plane reservation page 500 may be communicated to an Internet user through the use of one or more Web pages. Plane information fields 502 are used to submit information reservation parameters in association with a supplier's plane, or planes, used to complete flights. Information and parameters may include plane tail number and aircraft type, as well as flight blackout dates, usable seats, and weight requirements. By engaging an “Add Plane” button 504, the user submits the information provided in plane information fields 502 to reservation engine 313, thereby being stored in one or more databases, for example reservation master database 314 and inventory database 315. Storage of information may be accomplished through the same mechanisms as identified in FIG. 4 above. Information submitted by engaging “Add Plane” button 504 may be used to generate reservation options in relation to the supplier's account.

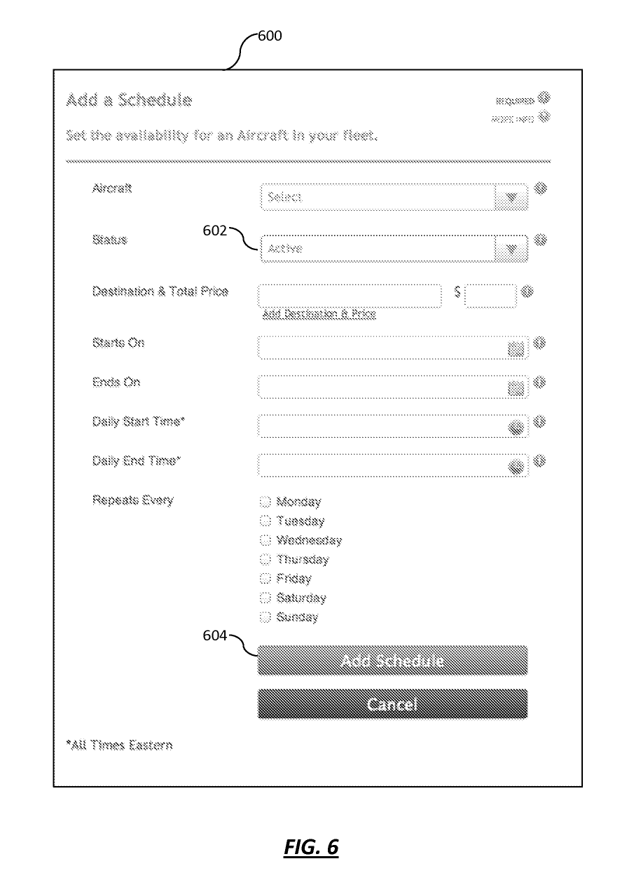

FIG. 6 illustrates an exemplary schedule information page that may be communicated by the air travel reservation system. In an embodiment, schedule information page 600 may be communicated to an Internet user through the use of one or more Web pages. Schedule fields 602 are used to populate reservation parameters, for example aircraft, status, destination, total price for flight, and schedule. By engaging an “Add Schedule” button 604, the user submits the information provided in schedule fields 602 to reservation engine 313, thereby being stored in one or more databases, for example inventory database 315. Storage of information may be accomplished through the same mechanisms as identified in FIG. 4 above. Reservation engine 313 may use information submitted through engaging “Add Schedule” button 604 to generate flight options, such flight options being viewable to an Internet user through communication of one or more Web pages.

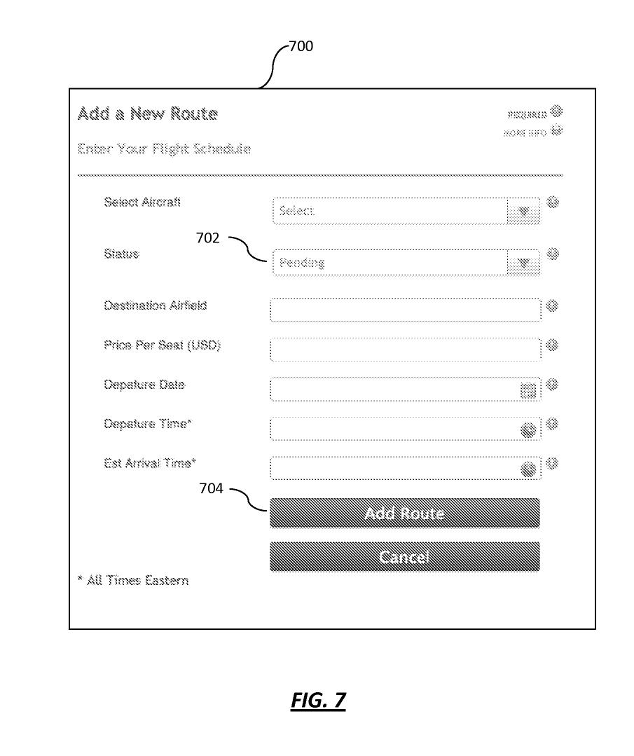

FIG. 7 illustrates an exemplary route information page that may be communicated by the air travel reservation system. In an embodiment, route information page 700 may be communicated to an Internet user through the use of one or more Web pages. Storage of information may be accomplished through the same mechanisms as identified in FIG. 4 above. Route fields 702 are used to populate flight route parameters, for example aircraft used, status, destination airfield, price per seat, departure date, departure time, and estimated arrival time. By engaging an “Add Route” button 704, the user submits the information provided in route fields 702 to reservation engine 313, thereby being stored in one or more databases, for example inventory database 315. Reservation engine 313 may use information submitted through engaging “Add Route” button 704 to generate flight options and pricing, such flight options and pricing being viewable to an Internet user through communication of one or more Web pages.

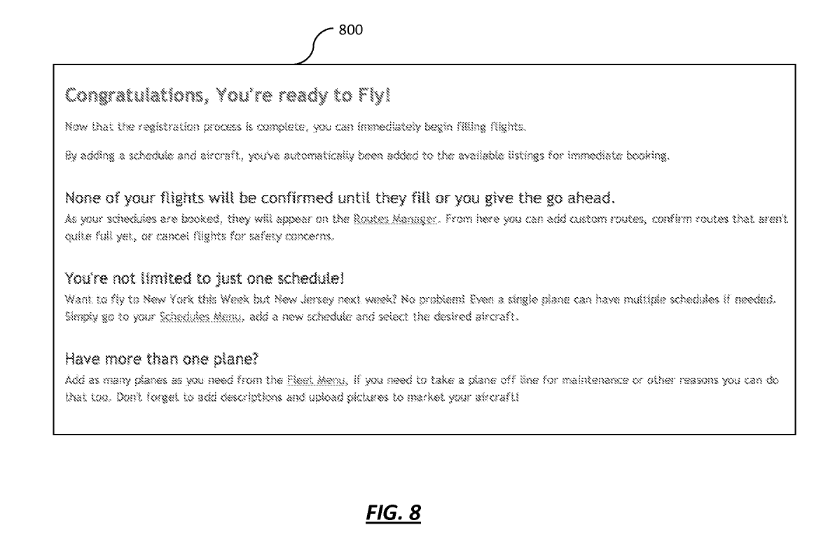

FIG. 8 illustrates an exemplary confirmation page that may be communicated by the air travel reservation system. In an embodiment, confirmation page 800 may be communicated to an Internet user through the use of one or more Web pages, an Internet user to include specifically a supplier having generated a supplier account in accordance with FIG. 4 above, and generated supplier information in accordance with FIGS. 5-7 above. Confirmation page 800 is communicated to the user upon successful submission of the above information to reservation engine 313 and storage of information into one or more databases, including reservation master database 314 and inventory database 315.

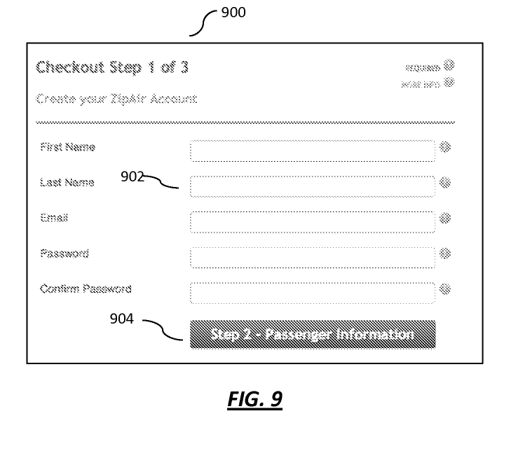

FIG. 9 illustrates an exemplary traveler checkout page that may be communicated by the air travel reservation system. In an embodiment, a Checkout Step 1 page 900 is communicated to an Internet user through the use of one or more Web pages. Checkout Step 1 page 900 is used to gather information from a potential traveler to generate a traveler account and complete a transaction to confirm a requested reservation. User information fields 902 are used to populate user information, such as name, e-mail address, and account password. By engaging a “Step 2—Passenger Information” button 904, the user submits the information provided in user information fields 902 to reservation engine 313, thereby being stored in one or more databases, for example reservation master database 314. Reservation engine 313 may use information submitted through engaging “Step 2—Passenger Information” button 904 to generate a reservation system user account, such account operable to identify a user through submission of a user password in a user interface. Storage of information may be accomplished through the same mechanisms as identified in FIG. 4 above.

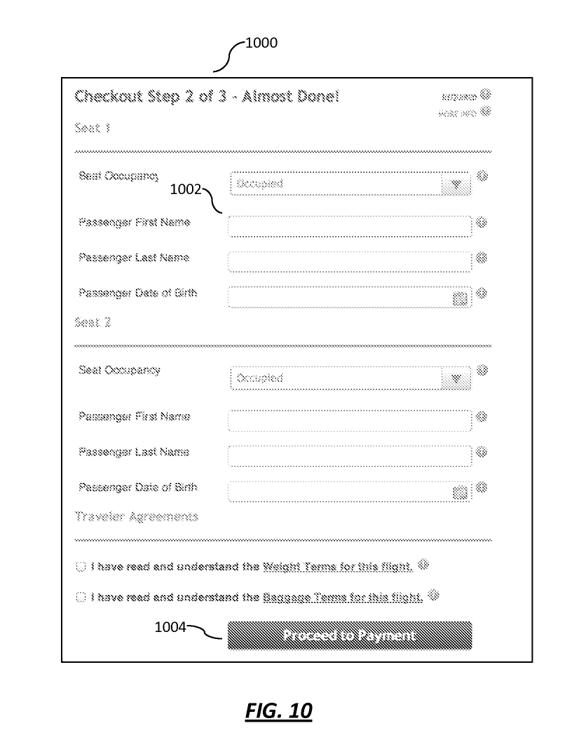

FIG. 10 illustrates an exemplary traveler checkout page that may be communicated by the air travel reservation system. In an embodiment, a Checkout Step 2 page 1000 is communicated to an Internet user through the use of one or more Web pages. Checkout Step 2 page 1000 is used to gather information from a potential traveler to generate a reservation request and complete a transaction associated with the reservation request. Passenger information fields 1002 are used to populate passenger information, such as name, date of birth, and seat occupancy. By engaging a “Proceed to Payment” button 1004, the user submits the information provided in user information fields 1002 to reservation engine 313, thereby being stored in one or more databases, for example reservation master database 314. The information submitted by engaging “Proceed to Payment” button 1004 is used by reservation engine 313 to generate a reservation according to the reservation information communicated by the traveler.

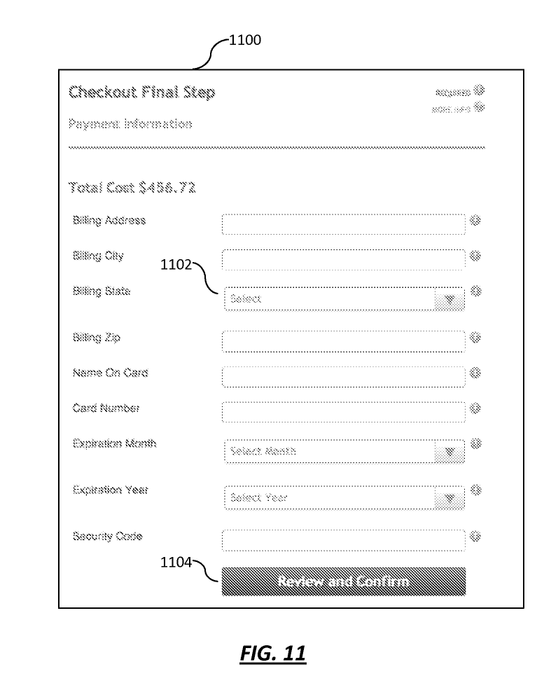

FIG. 11 illustrates an exemplary payment information page that may be communicated by the air travel reservation system. In an embodiment, the payment information page 1100 is communicated to an Internet user through the use of one or more Web pages. Payment information page 1100 is used to populate traveler credit card information to enable a transaction associated with the reservation request. Payment information fields 1102 are used to populate payment information, such as billing address, billing city, billing state, billing zip, and credit card numbers. By engaging a “Review and Confirm” button 1104, the user submits the information provided in payment information fields 1102 to reservation engine 313, thereby being stored in one or more databases, for example reservation master database 314. The information submitted by engaging “Review and Confirm” button 1104 is used by reservation engine 313 to conduct a transaction associated with the reservation request. Storage of information may be accomplished through the same mechanisms as identified in FIG. 4 above.

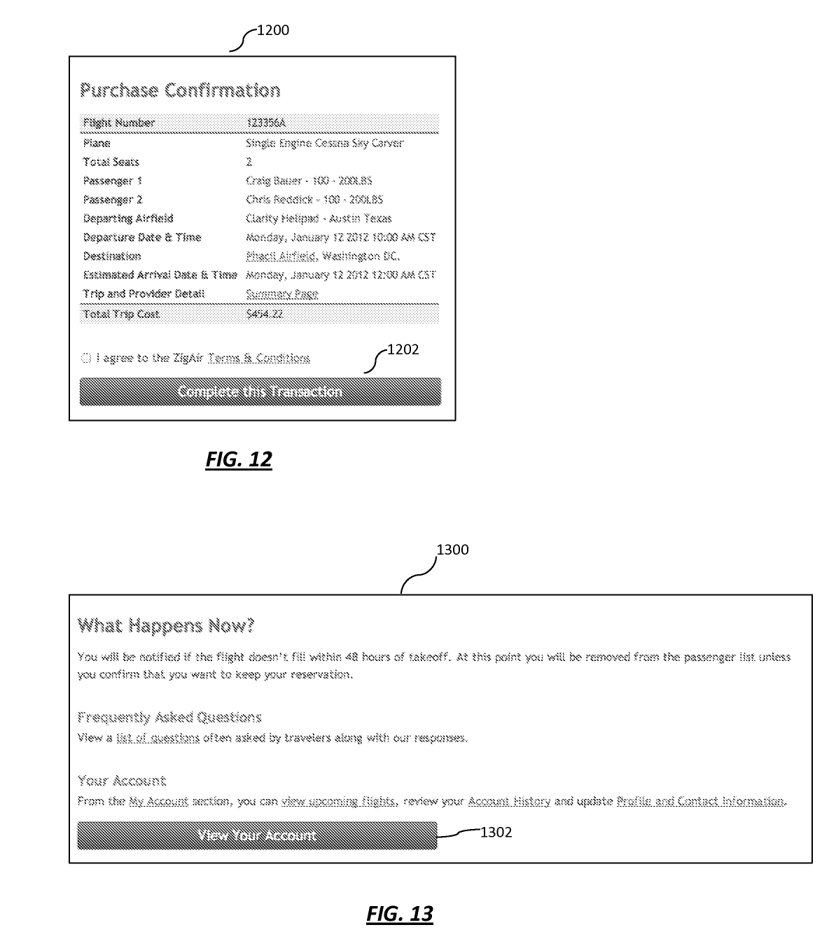

FIG. 12 illustrates an exemplary reservation confirmation page that may be communicated by the air travel reservation system. In an embodiment, reservation confirmation page 1200 is communicated to an Internet user through the use of one or more Web pages. Reservation confirmation page 1200 may display all reservation parameters, such as selected plane, total seats purchased, total cost, passengers, departing airfield, departure date and time, destination, estimated date and time, and access to trip and provider details. By engaging a “Complete this Transaction” button 1202, the user confirms the accuracy of the content displayed by reservation confirmation page 1200, and submits a reservation request to reservation engine 313. Reservation engine 313 conducts a transaction associated with the reservation request and creates a reservation. The transaction and reservation may be stored in one or more databases, including reservation master database 314 and inventory database 315. Storage of information may be accomplished through the same mechanisms as identified in FIG. 4 above. Upon receipt of a reservation request, reservation engine 313 may update flight availability information in inventory database 313, and aggregate the reservation request with other requests for the same flight, thereby satisfying the price parameters submitted by the supplier.

FIG. 13 illustrates an exemplary flight notification page that may be communicated by the air travel reservation system. In an embodiment, flight notification page 1300 is communicated to an Internet user through the use of one or more Web pages. Flight notification page 1300 informs the viewer that the reservation may not be executed if the price parameters submitted by the supplier are not satisfied. In an exemplary embodiment, if the traveler's flight does not possess the requisite number of reservations within 48 hours of departure, the traveler will be removed from the flight and the transaction will be cancelled, unless the traveler wishes to purchase more seats or exercise another suitable option generated by reservation engine 313. By engaging a “View Your Account” button 1302 the user can access account information and transaction history by viewing one or more Web pages which communicate the account information stored in reservation master database 314. The user's account information, such as account name and password, are used by reservation engine 313 to retrieve account information stored in reservation master database 314, or another suitable database.

All processes and embodiments identified above may also be practiced in distributed computing environments where tasks are performed by remote processing devices that are linked through a communications network.

Although the present invention has been described with several embodiments, numerous changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. An air travel reservation transaction system comprising:
at least one database receiving input from a user, the at least one database operable to store supplier information and traveler information; and
a reservation engine executing on one or more microprocessors operable to:
receive a reservation request;
access the at least one database to obtain the supplier information and the traveler information associated with the reservation request;
assign asset and demand values to supplier information and traveler information;
aggregate the reservation request with other reservation requests stored in the at least one database;
determine asset flight execution based upon satisfaction of a predetermined number of required reservation requests and satisfaction of predetermined supplier route parameters, the satisfaction of the predetermined number of required reservation requests and satisfaction of the predetermined supplier route parameters being determined by computing the asset and demand values;
generate asset flight options by assigning weight and relevance values to the asset and demand values, the weight and relevance values being computed to determine a relevance score, the relevance score being used to generate a hierarchy of the asset flight options; and,
complete a transaction associated with the reservation request.

2. (canceled)

3. The air travel reservation transaction system of claim 1, wherein the reservation engine is further operable to cancel the reservation request where the reservation request when aggregated is non-compliant with predetermined availability and price parameters stored in the at least one database.

4. The air travel reservation transaction system of claim 1, wherein:
the air travel reservation transaction system is coupled to the Internet; and the reservation engine is further operable to:
receive the reservation request from an electronic device coupled to the Internet; and
communicate a list of reservation options to the electronic device in the form of at least one Web page.

5. (canceled)

6. The air travel reservation system of claim 1, wherein the reservation engine is further operable to assign asset values to information communicated by air travel suppliers; assign demand values to information communicated by travelers; and assign weight and relevance values to asset and demand values based on route and availability variables.

7. (canceled)

8. The air travel reservation transaction system of claim 1, wherein the reservation engine is further operable to:
assign alternative reservation parameters to the reservation request, the alternative reservation parameters generated by evaluating the weight and relevance values and matching available air travel options and parameters to the reservation request stored in the at least one database; and
communicate alternative reservation parameters and confirmation options to a user.

9. The air travel reservation transaction system of claim 3, wherein the reservation engine is further operable to update asset and demand values in the at least one database in response to a cancellation of a reservation request.

10. The air travel reservation transaction system of claim 6, wherein the reservation engine is further operable to:
update asset and demand values stored in the at least one database in response to reservation completion data; and
issue a payment authorization to the supplier upon completion of an asset flight.

11. An air travel reservation system comprising:
at least one database receiving input from a user, the at least one database operable to store supplier information and traveler information; and
a reservation engine operable to:
receive a reservation request, the reservation request including at least one parameter;
assign asset and demand values to supplier information and traveler information;
access the at least one database to obtain information associated with the request;
aggregate the reservation request with other reservation requests stored in the at least one database;
determine asset flight execution based upon satisfaction of a predetermined number of required reservation requests and satisfaction of predetermined supplier route parameters, the satisfaction of the predetermined number of required reservation requests and satisfaction of the predetermined supplier route parameters being determined by computing the asset and demand values;
generate asset flight options by assigning weight and relevance values to the asset and demand values, the weight and relevance values being computed to determine a relevance score, the relevance score being used to generate a hierarchy of the asset flight options;
assign alternative reservation parameters to the reservation request, the alternative reservation parameters generated by matching available air travel options and parameters to the reservation request stored in the at least one database;
communicate alternative reservation parameters and confirmation options to a user; and,
create a reservation according to the reservation request.

12. (canceled)

13. (canceled)

14. The air travel reservation system of claim 11, wherein the reservation engine is further operable to assign asset values to flight inventory communicated by air travel suppliers, assign demand values to reservation requests communicated by travelers, and assign weight and relevance values to asset and demand values based on route and availability variables.

15. The air travel reservation system of claim 11, wherein the reservation engine is coupled to the Internet, and the reservation engine is further operable to:
receive reservation requests from an electronic device coupled to the Internet; and
communicate a list of air travel reservation options to the electronic device in the form of at least one Web page.

16. (canceled)

17. A computer implemented method for making air travel reservations, comprising:
receiving air travel options and parameters from an air travel supplier;
storing the air travel options and parameters into at least one database;
displaying the air travel options and parameters over the Internet through the use of at least one Web page, the at least one Web page accessible to Internet users;
receiving an air travel reservation request from an Internet user;
aggregating the air travel reservation request with similar air travel reservation requests on a reservation engine executing on one or more microprocessors, the reservation engine operable to determine asset flight execution based upon satisfaction of a predetermined number of required reservation requests and supplier route parameters;
generating asset flight options by assigning weight and relevance values to the asset and demand values, the weight and relevance values being computed to determine a relevance score, the relevance score being used to generate a hierarchy of the asset flight options;
assigning alternative reservation parameters for the reservation request executed by the reservation engine, the alternative reservation parameters generated by matching available air travel options and parameters to the reservation request;
communicating alternative reservation parameters and confirmation options to the Internet user; and
creating an air travel reservation.

18. (canceled)

19. The computer implemented method for making air travel reservations of claim 17, further comprising combining the aggregated air travel reservation requests to satisfy the predetermined number of required reservation requests and supplier route parameters.

20. The computer implemented method of claim 17, further comprising assigning asset values to flight inventory communicated by air travel suppliers, assigning demand values to information communicated by travelers, and assigning weight and relevance values to asset and demand values based on route and availability variables.
